(19) United States
(12) Patent Application Publication
(10) Pub. No.: US 2024/0406657 A1
(43) Pub. Date: Dec. 5, 2024

(54) SPATIAL AUDIO PLAYBACK WITH ENHANCED IMMERSIVENESS

(71) Applicant: Sonos, Inc., Santa Barbara, CA (US)

(72) Inventor: Paul Peace, Boston, MA (US)

(21) Appl. No.: 18/691,019

(22) PCT Filed: Sep. 14, 2022
(86) PCT No.: PCT/US2022/076416

§ 371 Date: Mar. 11, 2024

Related U.S. Application Data
(60) Provisional application No. 63/261,190, filed on Sep. 14, 2021.
(60) Provisional application No. 63/262,123, filed on Oct. 5, 2021.

(51) Int. Cl. H04S 7/00; H04R 5/02; H04R 5/04; H04S 3/00

(52) U.S. Cl. CPC H04S 7/302; H04R 5/02; H04R 5/04; H04S 3/008; H04S 2400/01; H04S 2400/11; H04S 2400/13

(57) ABSTRACT

A method of playing back audio content with improved immersiveness can include receiving, at a playback device, audio input including surround audio content. The playback device can include at least one forward-firing transducer configured to direct sound along a forward axis of the playback device and toward an intended listening location, and at least one side-firing transducer configured to direct sound along a side axis that is horizontally angled with respect to the forward axis. The method includes playing back at least a first portion of the surround audio content via the side-firing transducer(s) such that the first portion of the surround audio propagates along the side axis to be reflected towards the listening location. A second portion of the surround audio content is played back via the forward-firing transducer(s) such that the second portion of the surround audio propagates along the forward axis towards the listening location.

### CROSS-REFERENCE TO RELATED APPLICATIONS

This application claims priority to U.S. Patent Application No. 63/261,190, filed Sep. 14, 2021, and U.S. Patent Application No. 63/262,123, filed Oct. 5, 2021, which are incorporated herein by reference in their entireties.

### FIELD OF THE DISCLOSURE

The present disclosure is related to consumer goods and, more particularly, to methods, systems, products, features, services, and other elements directed to media play back or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media play back systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, embodiments, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with embodiments of the disclosed technology.

FIG. 1B is a schematic diagram of the media play back system of FIG. 1A and one or more networks.

FIG. 1C is a block diagram of a play back device.

FIG. 1D is a block diagram of a playback device.

FIG. 1E is a block diagram of a network microphone device.

FIG. 1F is a block diagram of a network microphone device.

FIG. 1G is a block diagram of a playback device.

FIG. 1H is a partially schematic diagram of a control device.

FIG. 2A is a front isometric view of a playback device configured in accordance with embodiments of the disclosed technology.

FIG. 2B is a front isometric view of the playback device of FIG. 3A without a grille.

FIG. 2C is an exploded view of the playback device of FIG. 2A.

FIG. 3A is a perspective view of a playback device configured in accordance with embodiments of the disclosed technology.

FIG. 3B is a transparent view of the playback device of FIG. 3A illustrating individual transducers.

FIG. 4 is schematic illustrations of audio playback in accordance with embodiments of the disclosed technology.

FIGS. 5A and 5B are example frequency response plots in accordance with embodiments of the disclosed technology.

FIGS. 5C and 5C are example audio spectrograms in accordance with embodiments of the disclosed technology.

FIG. 6 is a schematic block diagram of a signal processing scheme for audio play back in accordance with embodiments of the disclosed technology.

FIG. 7 is a flow diagram of an example process for playing back spatially immersive audio in accordance with embodiments of the disclosed technology.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Conventional surround sound audio rendering formats include a plurality of channels configured to represent different lateral positions with respect to a listener (e.g., front, right, left, right and left surrounds, right and left rear, etc.). More recently, three-dimensional (3D) or other immersive audio rendering formats have been developed that include one or more height (or vertical) channels in addition to any lateral channels. Examples of such 3D audio formats include DOLBY ATMOS, MPEG-H, and DTS: X formats.

In some examples, a playback device can be configured to play back one or more channels along a side-oriented direction. This directionality can be accomplished by use of dedicated arrays configured to steer audio output along a side axis, and/or with the use of “side-firing” transducers (e.g., transducers configured to direct sound along an axis that is horizontally angled with respect to a forward axis of the play back device). Audio directed along such a side-propagating axis may reflect off an acoustically reflective surface (e.g., a wall) towards the listener, allowing the listener to localize the sound as having originated from the reflection point. However, in practice at least a portion of such side-directed audio propagates along a forward direction towards the listener. This can be referred to as forward “leakage” of the side-directed audio content. Conventional approaches have sought to minimize or eliminate the forward leakage in favor of the side-directed audio. However, it is generally impractical or impossible to eliminate forward leakage, and in conventional approaches the forward-leaked audio has undesirable characteristics (e.g., a frequency response that deviates significantly from that of the side-directed audio) that create a poor listening experience for the user.

Embodiments of the present technology differ from the conventional approach by leveraging both the forward-propagating audio and the side-propagating audio to achieve the desired immersive audio experience for the listener. In particular, by ensuring that the audio reaching the listener via the forward-propagating path and the side-propagating path have similar acoustic characteristics (e.g., frequency response), the listener will perceive the two audio signals as originating from a single source at a location somewhere between the transducer (due to the forward-propagating audio) and the reflection point (due to the side-propagating audio). Due to the well-known precedence effect, the listener's perception regarding localization will be dominated by the first signal to reach the listener unless the subsequent signal is significantly louder than the first. Due to the shorter path length, the forward-propagating audio will reach the listener first, with the side-propagating audio reaching the user slightly later. To achieve the desired psychoacoustic effect, therefore, the side-propagating audio may be output with a higher acoustic energy and/or a higher sound pressure level (SPL) than the forward-propagating audio (e.g., at least 1, 2, 3, 4, 5, 6, 7, 8, 9, or 10 dB greater). Additionally, the array used to output side-directed audio can be configured such that the side-propagating audio and the forward-propagating audio have similar characteristics to one another (e.g., a frequency response that deviates by less than a threshold amount over a desired range of frequencies). By ensuring that the side-propagating and forward-propagating audio are acoustically similar to one another, the user is more likely to perceive the combined arrival of the side-propagating and forward-propagating audio as originating from a virtual source that is offset to the side of the play back device.

In some examples, the present technology provides a playback device configured to receive multi-channel audio input (e.g., having nine or more channels) and to combine certain channels together for processing via common arrays. Consider an incoming signal with nine channels: left, right, center, left surround, right surround, left rear, right rear, left height, and right height. In some implementations, five arrays can be used to direct audio output to the various transducers based on the incoming signals. A left array, right array, and center array can each be configured to output incoming left, right, and center channels, respectively. Additionally, the incoming left surround, left rear, and left vertical channels can be combined into a single array (referred to herein as an Lsrh array—for left surround, rear, and height array), and the incoming right surround, right rear, and right height channels can be combined into a single array (referred to herein as an Rsrh array). As a result, the five arrays (left, right, center, Lsrh, and Rsrh) can effectively process the incoming audio signals to be output via a plurality of transducers of a playback device such as a soundbar. Moreover, the Left, Right, Lsrh, and Rsrh arrays can each be configured such that the audio signals are directed along both side-propagating and forward-propagating directions in a manner that, as noted above, achieves an improved psychoastoustic effect for the listener. The net result is enhanced immersiveness, with the listener more reliably localizing side audio content (e.g., left surround) at a lateral position between the transducer and the reflective point.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

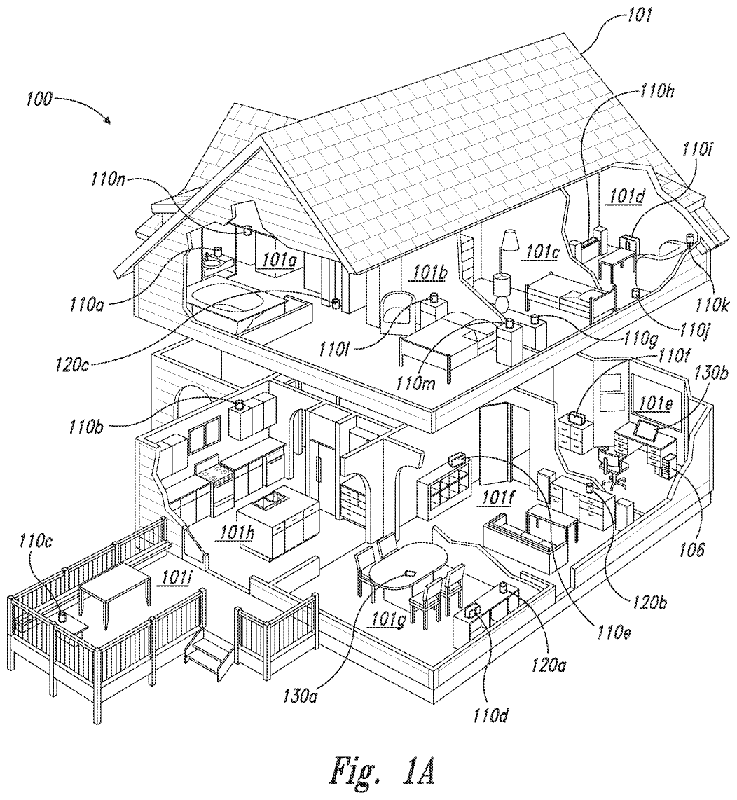

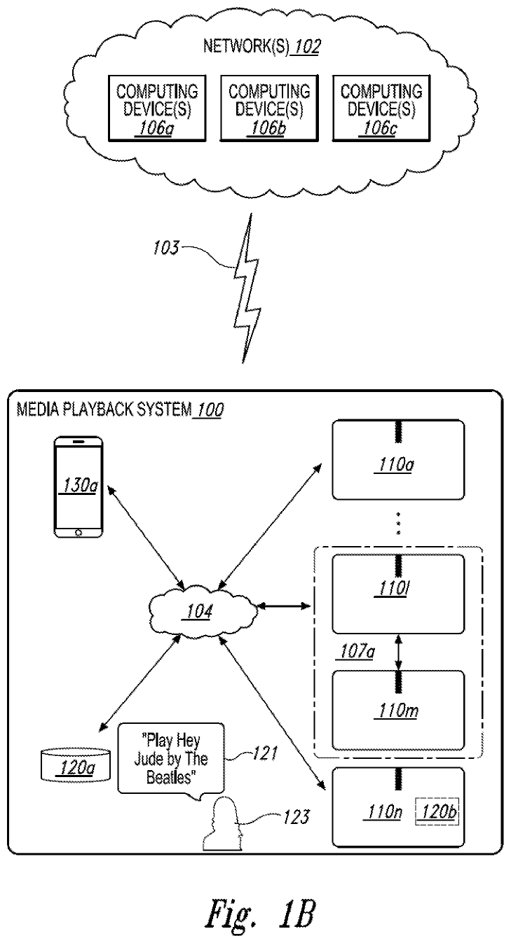

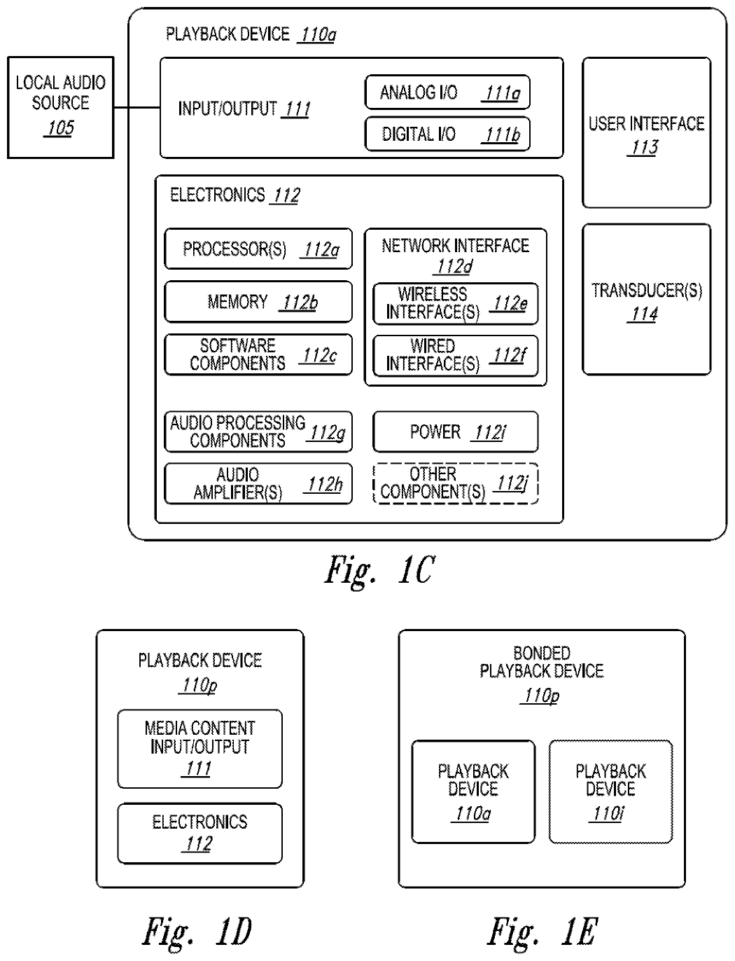

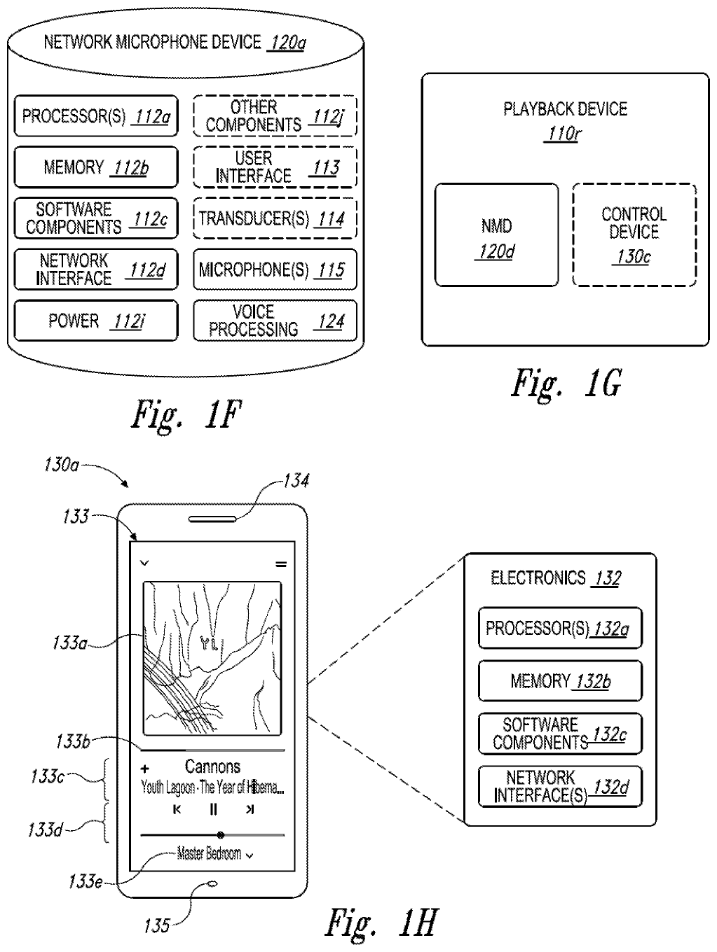

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices (“NMDs”), 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media play back system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media play back system 100 can play back audio via one or more of the play back devices 110. In certain embodiments, the playback devices 110 are configured to commence play back of media content in response to a trigger. For instance, one or more of the play back devices 110 can be configured to play back a morning playlist upon detection of an associated trigger condition (e.g., presence of a user in a kitchen, detection of a coffee machine operation). In some embodiments, for example, the media play back system 100 is configured to play back audio from a first playback device (e.g., the play back device 110a) in synchrony with a second play back device (e.g., the playback device 110b). Interactions between the playback devices in 110. NMDs 120, and/or control devices 130 of the media play back system 100 configured in accordance with the various embodiments of the disclosure are described in greater detail below:

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media play back system 100 can comprise one or more playback zones, some of which may correspond to the rooms in the environment 101. The media play back system 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some embodiments, a single play back zone may include multiple rooms or spaces. In certain embodiments, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of play back devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B and 1E.

In some embodiments, one or more of the playback zones in the environment 101 may each be playing different audio content. For instance, a user may be grilling on the patio 101i and listening to hip hop music being played by the play back device 110c while another user is preparing food in the kitchen 101h and listening to classical music played by the play back device 110b. In another example, a playback zone may play the same audio content in synchrony with another playback zone. For instance, the user may be in the office 101e listening to the playback device 110f playing back the same hip hop music being played back by playback device 110c on the patio 101i. In some embodiments, the playback devices 110c and 110f play back the hip hop music in synchrony such that the user perceives that the audio content is being played seamlessly (or at least substantially seamlessly) while moving between different playback zones. Additional details regarding audio playback synchronization among play back devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media play back system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some embodiments, the cloud network 102 is further configured to receive data (e.g. voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media play back system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11 aj, 802.11aq, 802.11ax, 802.11ay, 802.15, etc. transmitted at 2.4 Gigahertz (GHz), 5 GHZ, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household communication network (e.g., a household WiFi network). In some embodiments, the links 103 and the network 104 comprise one or more of the same networks. In some embodiments, for example, the links 103 and the network 104 comprise a telecommunication network (e.g., an LTE network, a 5G network). Moreover, in some embodiments, the media play back system 100 is implemented without the network 104, and devices comprising the media playback system 100 can communicate with each other, for example, via one or more direct connections, PANs, telecommunication networks, and/or other suitable communication links.

In some embodiments, audio content sources may be regularly added or removed from the media play back system 100. In some embodiments, for example, the media play back system 100 performs an indexing of media items when one or more media content sources are updated, added to, and/or removed from the media play back system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media play back system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the play back devices 110.

The media play back system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) transmit a corresponding command to the media playback system 100. In some embodiments, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103. In response to receiving the voice input data, the computing device 106c processes the voice input data (i.e., “Play Hey Jude by The Beatles”), and determines that the processed voice input includes a command to play a song (e.g., “Hey Jude”). The computing device 106c accordingly transmits commands to the media play back system 100 to play back “Hey Jude” by the Beatles from a suitable media service (e.g., via one or more of the computing devices 106) on one or more of the play back devices 110.

b. Suitable Playback Devices

FIG. 1C is a block diagram of the play back device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WiFi, Bluetooth, or another suitable communication protocol. In certain embodiments, the analog I/O 111a and the digital 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some embodiments, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 is configured to receive audio from an audio source (e.g., the local audio source 105) via the input/output 111, one or more of the computing devices 106a-c via the network 104 (FIG. 1B)), amplify the received audio, and output the amplified audio for play back via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the play back device 110a to synchronize play back of audio content with another of the one or more play back devices 110. As those of ordinary skill in the art will appreciate, during synchronous play back of audio content on a plurality of play back devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the play back device 110a. The memory 112b can also include data associated with a state of one or more of the other devices (e.g., the play back devices 110, NMDs 120, control devices 130) of the media playback system 100. In some embodiments, for example, the state data is shared during predetermined intervals of time (e.g., every 5 seconds, every 10) seconds, every 60) seconds) among at least a portion of the devices of the media playback system 100, so that one or more of the devices have the most recent data associated with the media play back system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some embodiments, the network interface 112d optionally includes a wired interface 112f (e.g., an interface or receptacle configured to receive a network cable such as an Ethernet, a USB-A. USB-C. and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, a digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some embodiments, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz. (Hz) and 20 kilohertz. (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein. “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 KHz.

By way of illustration, SONOS, Inc. presently offers (or has offered) for sale certain play back devices including, for example, a “SONOS ONE,” “MOVE,” “PLAY: 5,” “BEAM,” “PLAYBAR.” “PLAYBASE.” “PORT.” “BOOST,” “AMP.” and “SUB.” Other suitable play back devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-ear earphones). In other embodiments, one or more of the play back devices 110 comprise a docking station and/or an interface configured to interact with a docking station for personal mobile media playback devices. In certain embodiments, a play back device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

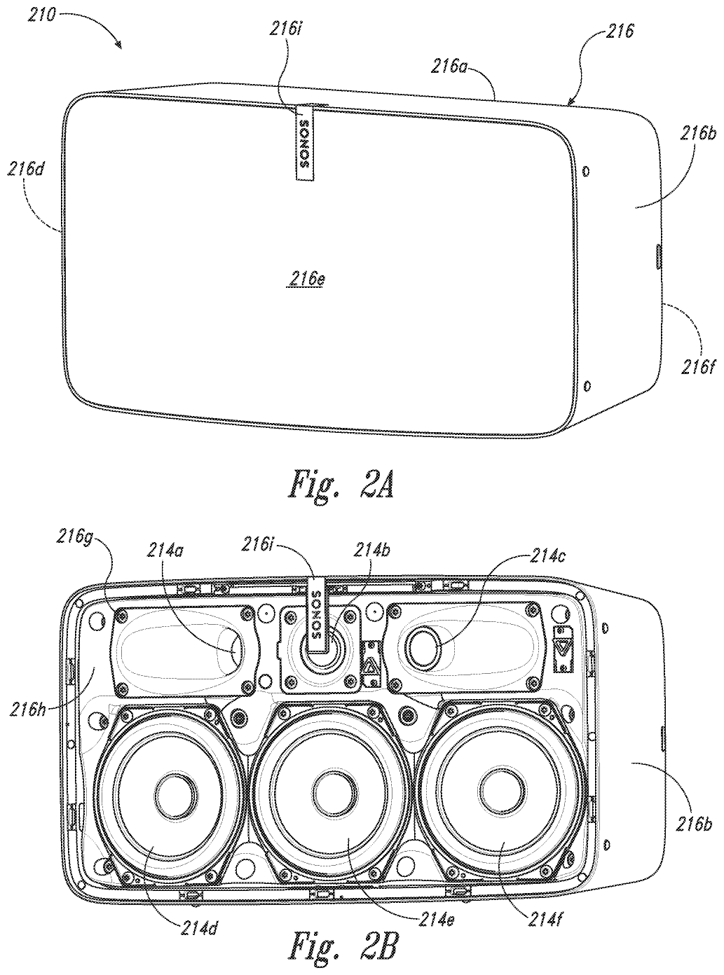

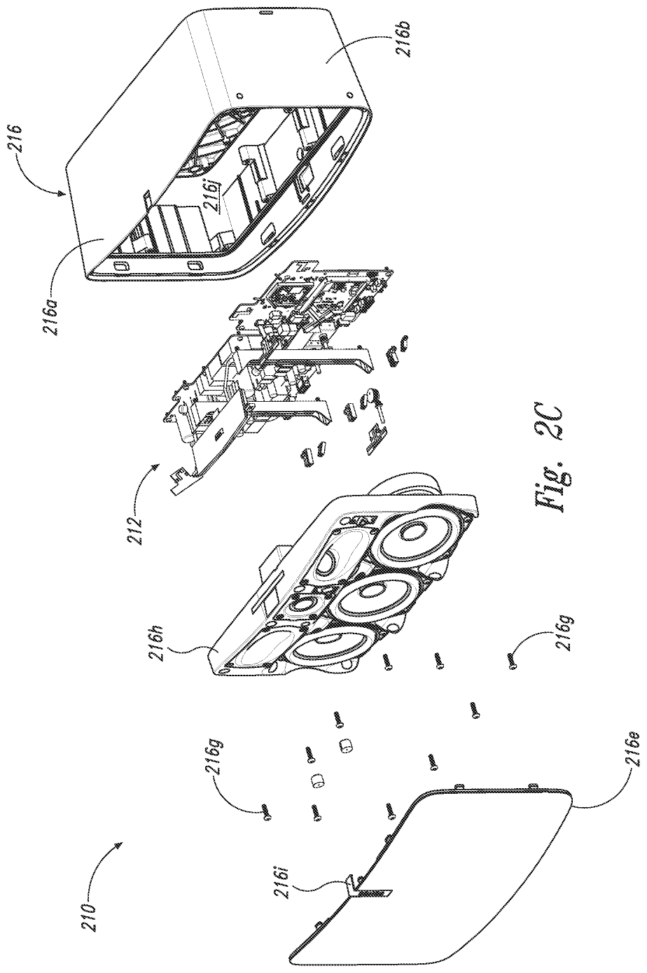

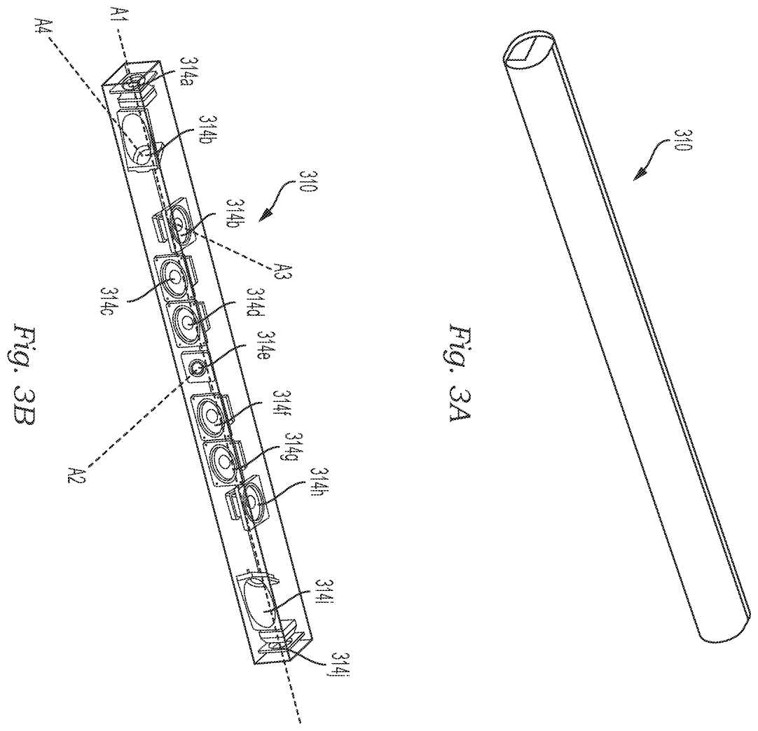

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the play back devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded play back device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some embodiments, the playback device 110a, when bonded with the first play back device, is configured to render only the mid-range and high frequency components of a particular audio content, while the play back device 110i renders the low frequency component of the particular audio content. In some embodiments, the bonded playback device 110q includes additional playback devices and/or another bonded playback device. Additional playback device embodiments are described in further detail below with respect to FIGS. 2A-2C.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the play back device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media play back device (e.g., one or more of the playback devices 110), and further includes, for example, one or more of the audio components 112g (FIG. 1C), the amplifiers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing components 124, and only a portion of the components of the electronics 112 described above with respect to FIG. 1B. In some embodiments, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a play back device 110r comprising an NMD 120d. The play back device 110r can comprise many or all of the components of the playback device 110a and further include the microphones 115 and voice processing components 124 (FIG. 1F). The play back device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing components 124 receive and analyzes the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLER VAS and “Hey, Siri” for invoking the APPLE® VAS.

After detecting the activation word, voice processing components 124 monitor the microphone data for an accompanying user request in the voice input. The user request may include, for example, a command to control a third-party device, such as a thermostat (e.g., NEST®; thermostat), an illumination device (e.g., a PHILIPS HUE R lighting device), or a media playback device (e.g., a Sonos R: playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Control Devices

FIG. 1H is a partially schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™ an Android phone) on which media play back system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the media play back system 100. In other embodiments, as described above with respect to FIG. 1G, the control device 130a is integrated into another device in the media play back system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media play back system 100. The memory 132b can comprise data storage that can be loaded with one or more of the software components executable by the processor 132a to perform those functions. The software components 132c can comprise applications and/or other executable software configured to facilitate control of the media playback system 100. The memory 112b can be configured to store, for example, the software components 132c, media play back system controller application software, and/or other data associated with the media playback system 100 and the user.

The network interface 132d is configured to facilitate network communications between the control device 130a and one or more other devices in the media play back system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media play back systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 130 to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others.

The user interface 133 is configured to receive user input and can facilitate ‘control of the media play back system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media play back system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some embodiments, for example, the control device 130a is configured as a playback device (e.g., one of the play back devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

### III. Example Systems and Devices for Improved Immersiveness

FIG. 2A is a front isometric view of a play back device 210 configured in accordance with embodiments of the disclosed technology. FIG. 2B is a front isometric view of the playback device 210 without a grille 216e. FIG. 2C is an exploded view of the playback device 210. Referring to FIGS. 2A-2C together, the play back device 210 comprises a housing 216 that includes an upper portion 216a, a right or first side portion 216b, a lower portion 216c, a left or second side portion 216d, the grille 216e, and a rear portion 216f. A plurality of fasteners 216g (e.g., one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a-f). The electronics 212 (e.g., the electronics 112 of FIG. 1C) is configured to receive audio content from an audio source and send electrical signals corresponding to the audio content to the transducers 214 for playback.

The transducers 214 are configured to receive the electrical signals from the electronics 112, and further configured to convert the received electrical signals into audible sound during playback. For instance, the transducers 214a-c (e.g., tweeters) can be configured to output high frequency sound (e.g., sound waves having a frequency greater than about 2 kHz). The transducers 214d-f (e.g., mid-woofers, woofers, midrange speakers) can be configured output sound at frequencies lower than the transducers 214a-c (e.g., sound waves having a frequency lower than about 2 kHz). In some embodiments, the play back device 210 includes a number of transducers different than those illustrated in FIGS. 2A-2C. For example, the play back device 210 can include fewer than six transducers (e.g., one, two, three). In other embodiments, however, the play back device 210 includes more than six transducers (e.g., nine, ten). Moreover, in some embodiments, all or a portion of the transducers 214 are configured to operate as a phased array to desirably adjust (e.g., narrow or widen) a radiation pattern of the transducers 214, thereby altering a user's perception of the sound emitted from the play back device 210.

In the illustrated embodiment of FIGS. 2A-2C, a filter 216i is axially aligned with the transducer 214b. The filter 216i can be configured to desirably attenuate a predetermined range of frequencies that the transducer 214b outputs to improve sound quality and a perceived sound stage output collectively by the transducers 214. In some embodiments, however, the playback device 210 omits the filter 216i. In other embodiments, the playback device 210 includes one or more additional filters aligned with the transducers 214b and/or at least another of the transducers 214.

FIG. 3A is a perspective view of a playback device 310, and FIG. 3B shows the device 310 with the outer body drawn transparently to illustrate the plurality of transducers 314a-j therein (collectively “transducers 314”). The transducers 314 can be similar or identical to any one of the transducers 214a-f described previously. In this example, the play back device 310 takes the form of a soundbar that is elongated along a horizontal axis A1 and is configured to face along a primary sound axis A2 that is substantially orthogonal to the first horizontal axis A1. In other embodiments, the play back device 310 can assume other forms, for example having more or fewer transducers, having other form-factors, or having any other suitable modifications with respect to the embodiment shown in FIGS. 3A and 3B.

The playback device 310 can include individual transducers 314a-j oriented in different directions or otherwise configured to direct sound along different sound axes. For example, the transducers 314c-g can be configured to direct sound primarily along directions parallel to the primary sound axis A2 of the play back device 310. Additionally, the playback device 310 can include left and right up-firing transducers (e.g., transducers 314b and 314h) that are configured to direct sound along axes that are angled vertically with respect to the primary sound axis A2. For example, the left up-firing transducer 314b is configured to direct sound along the axis A3, which is vertically angled with respect to the horizontal primary axis A2. In some embodiments, the up-firing sound axis A3 can be angled with respect to the primary sound axis A2 by between about 50 degrees and about 90 degrees, between about 60 degrees and about 80 degrees, or about 70 degrees.

The play back device 310 can optionally include one or more side-firing transducers (e.g., transducers 314a, 314b, 314i, and 314j), which can direct sound along axes that are horizontally angled with respect to the primary sound axis A2. In the illustrated embodiment, the outermost transducers 314a and 314j can be configured to direct sound primarily along the first horizontal axis A1 or at least partially horizontally angled therefrom, while the side-firing transducers 314b and 314i are configured to direct sound along an axis that lies between the axes A1 and A2. For example, the left side-firing transducer 314b is configured to direct sound along axis A4.

In playback devices that do not have such side-firing transducers, side-propagating audio can be achieved by use of arrays, in which the audio output by each transducer sums in manner that the combined output has a directivity and is oriented along a side-propagating axis.

In operation, the playback device 310 can be utilized to play back 3D audio content that includes a vertical component (also referred to herein as a “height component”). As noted previously, certain 3D audio or other immersive audio formats include one or more vertical channels in addition to any lateral (e.g., left, right, front) channels. Examples of such 3D audio formats include DOLBY ATMOS, MPEG-H, and DTS: X formats. In play back devices that do not have such up-firing transducers, upward-propagating audio can be achieved by use of arrays, in which the audio output by each transducer sums in manner that the combined output has a directivity and is oriented along a vertically propagating axis.

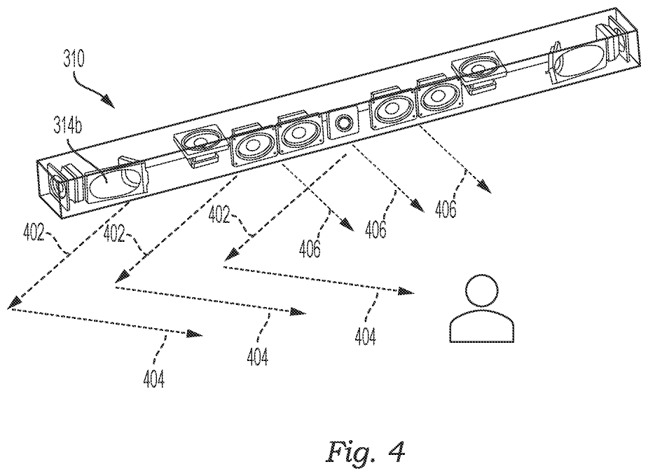

FIG. 4 schematically illustrates play back of surround audio content via the play back device 310. As illustrated, the playback device 310 can direct sound output 402 along the side-propagating axis (e.g., axis A4 in FIG. 3B). This output can be the result of one more side-firing transducers (e.g., side-firing transducer 314b). Additionally or alternatively, arraying can be used to produce a combined output of multiple different transducers (some or none of which may be dedicated side-firing transducers) that is oriented along the side-propagating axis. This output 402 can reflect off an acoustically reflective surface (e.g., a wall), after which the reflected output 404 reaches the listener at a target location. Because the listener perceives the audio output 404 as originating from point of reflection on the wall, the psychoacoustic perception is that the sound is to the side of the listener. However, this effect may be reduced due to forward “leakage,” indicated in FIG. 4 by line 406. Even with the use of waveguides and a dedicated side-firing transducer, a significant proportion of acoustic energy may still propagate along a forward direction. This is particularly true in lower frequencies, which tend to be output more omnidirectional than higher frequency audio. Since at least some of the low-frequency portion “leaks” along the forward direction as output 406, the user's perception of audio output by the playback device 310 may be a combination of the wall-reflected output 404 and the forward-propagating output 406. As noted previously, conventional approaches typically attempted to minimize or reduce the level of forward-propagating output 406 so as to increase the immersiveness and directionality of the audio. However, it typically not possible to eliminate forward-propagating audio content, even when using side-firing transducers with acoustic waveguides.

As such, the present technology utilizes a different approach. Rather than attempting to minimize or eliminate the forward-propagating audio, audio content (e.g., including surround, rear, and/or height channels) can be processed via an array that outputs the audio simultaneously along the side-propagating axis (e.g., as output along paths 402 and 404) and along a forward-propagating direction (e.g., as output along paths 406). In various examples, any number or subset of the transducers of the playback device 310 may be utilized in outputting audio based on the array.

In some examples, the reflected output 404 (e.g., the portion of the audio content that reaches the listener via reflection off the wall) can have a sound pressure level (SPL) at the target listening location that is greater than the SPL of the output 406 that propagates along the forward direction. For example, in various embodiments, the SPL of the reflected output 404 can be at least 1 dB, 2 dB, 3 dB, 4 dB, 5 dB, 6 dB, 7 dB, 8 dB, 9 dB, 10 dB, 11 dB 12 dB, 13 dB. 14 dB, 15 dB, 20 dB, 30 dB, 40 dB, or 50 dB greater than the forward-propagating output 406. In at least some embodiments, the reflected output 404 can have an SPL at the target listening location that is substantially the same as, or less than, the SPL of the forward-propagating output 406 at the target listening location.

Optionally, to ensure that the reflected output 404 and the forward-propagating output 502 reach the listener substantially simultaneously, play back of the audio content via the side-propagating axis 406 can be time-aligned (e.g. delayed or advanced) relative to audio output via the forward-propagating axis 406. This time alignment can be configured to compensate for the different path length that the side-firing output takes to reach the listener as compared to the forward-firing transducer output. In at least some examples, the playback device can be configured such that the forward-propagating audio reaches the listener first, followed by the reflected side-propagating audio content.

As a result of outputting at least part of the surround audio content via both side-propagating and forward-propagating directions, the listener may localize the audio content as originating from the wall from which the side-firing output has reflected. When substantially identical sounds reach a user from two different locations, the user will generally perceive the sounds as a single fused sound and as arriving from a location between those two locations. If one sound is louder than another, the apparent location of the perceived sound will be skewed toward the location associated with the louder sound. Additionally, due to the well-known precedence effect, if the two sounds do not reach the user simultaneously, the apparent location of the perceived sound will be dominated by the location of the sound that reached the user's ears first. Examples of the present technology take advantage of these phenomena to achieve the desired localization of side-firing audio content.

In the case of side-propagating audio that reflects off a wall and forward-propagating audio that reaches a user without reflection, the forward-propagating audio will reach the user first, as the direct path length between the transducer and the user is shorter than the path length of the reflected signal. As such, given the same acoustic energy of the forward-propagating signal and the side-propagating signal, the user will localize the audio as originating from a location much nearer to the soundbar than to the reflection point. This is generally undesirable as the audio content routed along a side-propagating axis is intended to be perceived by the user as originating from a location offset from the playback device. To achieve the desired psychoacoustic effect (e.g., the user localizing the side-firing audio content as originating from a location that is angled with respect to the forward axis of the play back device), it is beneficial to control the relative amplitudes of acoustic energy directed along each of the two directions. In particular, by directing a greater proportion of the acoustic energy along the side-propagating direction than along the forward-propagating direction (e.g., by at least 5 dB or more), the user will localize the sound as originating from an area between the reflection point and the soundbar, notwithstanding the fact that the forward-propagating audio reaches the user first. This distribution of acoustic energy between side-propagating and forward-propagating axes can be achieved at least in part based on use of arrays to process the various incoming audio channels.

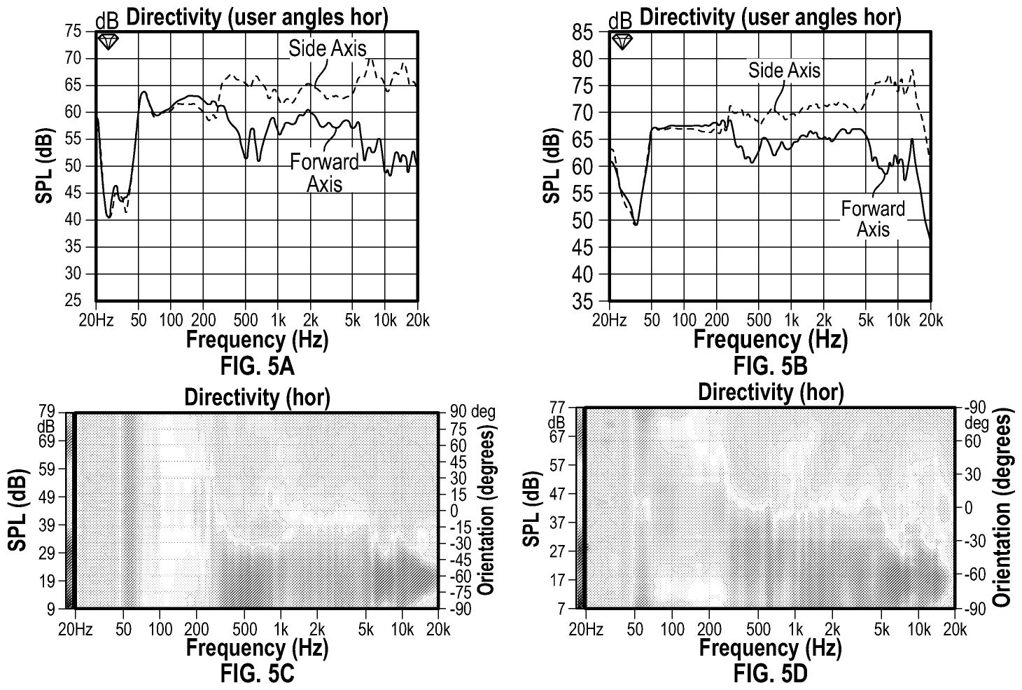

FIGS. 5A and 5B illustrate example frequency response plots. In each case, a frequency response for a particular playback device is measured along two directions: a forward axis (e.g., at 0) degrees with respect to a forward axis extending substantially perpendicular to a front face of the playback device) and a side axis (e.g., horizontally angled by 60 degrees with respect to the forward axis). In operation, one or more audio channels (e.g., left, left surround, left rear, etc.) may be output by the play back device such that a first portion of the audio propagates along the side axis (e.g., to be reflected off a wall towards a listener) and a second portion of the audio propagates along the forward axis (e.g., extending directly from the play back device to the listener).

FIG. 5A illustrates these respective frequency responses using conventional approaches, in which the array design is configured to eliminate audio propagating along the forward axis. FIG. 5B illustrates these respective frequency responses using the present technology, in which the array(s) are configured to incorporate both the forward-propagating and side-propagating audio in a manner that improves immersiveness. In one aspect, this improved immersiveness is achieved by reducing a difference in the frequency responses between the side-axis and the forward-axis. As shown in FIG. 5A, the side-axis frequency response deviates significantly from the forward-axis frequency response, both in sound pressure level (SPL) values and in the shape of the frequency response curve. In contrast, as shown in FIG. 5B, the frequency responses of the side axis and forward axis are more similar to one another. The improvement is particularly pronounced over the frequency range of about 300 Hz to about 5 kHz. In some embodiments, the frequency responses for each of these axis may differ from one another over a defined frequency range by less than a threshold amount (e.g., less than about 1, 2, 3, 4, 5, 6, 7, 8, 9, 10, 11, 12, 13, 14, 15, 16, 17, 18, 19, or 20 dB). In various examples, the defined frequency range can have a lower end of about less than 200, 200, 300, 400, 500, 600, 700, 809, 900, or 1,000 Hz, and an upper end of about 1, 1.5, 2, 2.5, 3, 3.5, 4, 4.5, 5, 5.5, 6, 6.5, 7, 7.5, 8, 8.5, 9, or 9.5 kHz or more. By selecting the array(s) to achieve generally similar frequency responses along both a side axis and a forward axis, a more immersive effect can be achieved. In particular, the similar acoustic properties of the output along the forward axis and the side axis ensure that the user will perceive the combined arrival of audio via the side axis (via reflection) and via the forward axis as originating from a “virtual speaker” or position that is horizontally offset from the play back device.

FIGS. 5C and 5D illustrate example spectrograms. These diagrams show output of a side-directed audio output (e.g., left or left rear channel, for example), represented by measurements of sound pressure levels as a heat map distributed over frequencies (horizontal axis) and orientations (vertical axis). In these diagrams, the orientations are measured as degrees of horizontal offset from the forward axis. The spectrogram in FIG. 5C corresponds to output of a conventional array (e.g., an array that outputs the frequency response plot in FIG. 5A), and the spectrogram in FIG. 5D corresponds to output of a playback device utilizing an arrays in accordance with the present technology (e.g., an array that outputs the frequency response plot in FIG. 5B). As seen in comparing FIG. 5C, in the conventional approach, the acoustic energy is concentrated along the side axis (e.g., at −60 degrees orientation), and drops off sharply moving towards the forward axis (0 degrees). Along the forward axis, however, there remains some acoustic energy at a heightened level, particularly over the range of about 1 kHz to about 5 kHz. This corresponds to the forward “leakage” that is generally impossible to eliminate completely.

In contrast, the output shown in FIG. 5D illustrates an output of acoustic energy that remains highest along the side axis (e.g., at −60 degrees orientation) but with a less rapid drop off in acoustic energy moving towards the forward axis (0 degrees). And along the forward axis, the acoustic energy output is more uniform as compared to that shown in FIG. 5C. By achieving this improved uniformity along the forward axis, the combined output of side-directed audio that propagates along a side axis and a forward axis provides enhanced immersiveness for the listener.

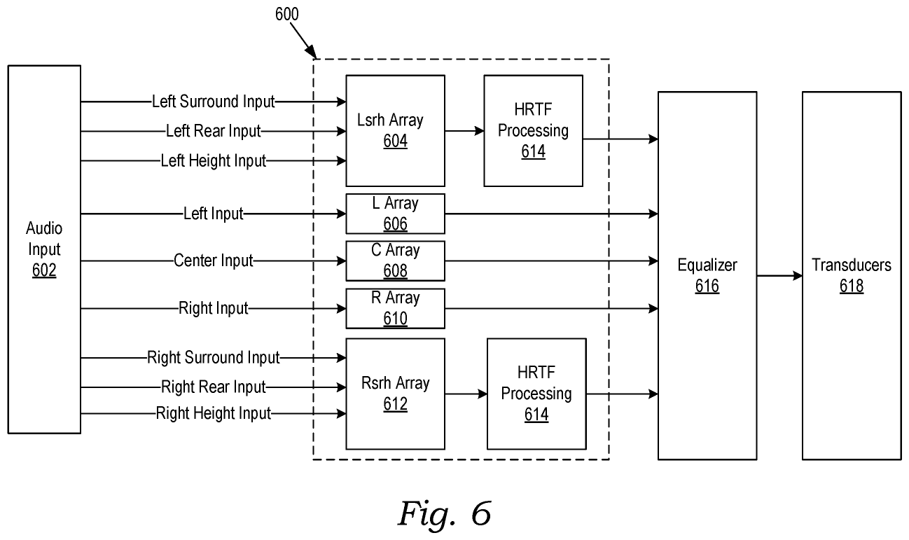

FIG. 6 is a schematic block diagram of a signal processing scheme for audio playback. The blocks illustrated in FIG. 6 can be implanted using digital or analog components or any combination thereof. As illustrated, audio input 602 can be provided to an audio processing module 600. The audio input 602 can include a plurality of channels, which may vary depending on the particular audio rendering format in use. In the illustrated example, the audio input 602 includes a left surround input, a right surround input, a left vertical input, and a right vertical input. In various embodiments, the audio input 602 can include more or fewer channels, and may conform to any suitable audio standard (e.g., DOLBY ATMOS, MPEG-H, or DTS: X). The output of the audio processing module 600 can be provided to an equalizer 616 that can modify various signals appropriately before being routed to the transducers 618 for play back.

As shown in FIG. 6, the audio processing module 600 includes a plurality of arrays that each receive one or more incoming input channels. In the illustrated example, the left array 606 receives the left input channel, the center array 608 receives the center input channel, and the right array 610 receives the right input channel. In the case of left surround input, left rear input, and left height input channels, these channels are together provided to a single Lsrh array 604. Similarly, the right surround input, right rear input, and right height input channels are together provided to a single Rsrh array 612. Each of these arrays can be configured to provide appropriate output signals to the transducers such that these surround audio channels are played back via transducers in a manner that achieves the desired spaciousness. In particular, the surround audio content (e.g., left surround input and right surround input) can be played back along both side-propagating and forward-propagating axes and having relative amplitudes such that the listener at a target listening location perceives the surround content as originating to the side of the listener (e.g., at a location between the play back device and the lateral reflection point).

Each of the Lsrh array 604 and the Rsrh array 612 can provide their respective outputs to head-related transfer function (HRTF) processing 614. The HRTF processing can include height cue and crosstalk cancellation filters, or other suitable filters or processing steps configured to achieve spaciousness and immersiveness in the audio output.

In some embodiments, the audio processing module 600 can be dynamically modified based on feedback. For example, one or more microphones disposed at or near a target listening area may be used to detect sounds output by the transducers. Based on the detected output sounds, the operation of the audio processing module 600 may be modified. Such dynamic updating can be beneficially used to tailor operation of the system to the particular room dimensions, target listening location, or other acoustic properties of the environment. For example, the wall location, ceiling height, listener distance, and other dimensions can alter the relative path lengths of output from the side-firing transducers and up-firing transducers. Accordingly, depending on the particular dimensions and other aspects of the environment, the particular parameters of the audio processing module 600 may be modified to achieve the desired psychoacoustic effects and improved immersiveness for the listener.

As an example, information indicating acoustic path lengths of the side-propagating audio content and the forward-propagating audio content may be received by the play back device before determining the respective amplitudes of the side-propagating audio content and the forward-propagating audio content. Such information could be a user indication of room dimensions and/or an approximate listening location. Alternatively, such information could be approximated by outputting audio signals along the side and forward-propagating axes and estimating respective acoustic path lengths based on receiving the audio signals at a microphone of the playback device or another microphone device located in the play back environment. Alternatively, acoustic path lengths and respective output amplitudes may be determined based on default values for common listening environments. In either case, the determined amplitudes may be adapted based on feedback received from one or more microphones located at or near the listening location.

Microphones at or near the listening location may receive output sound from the playback device. Based on the information recorded by these microphones, respective SPL or relative SPL of each of the portions of audio content output along the forward-propagating axis and the side-propagating axis or axes can be determined and used to adjust the determined amplitudes of the first and second portions of surround audio content output by the play back device. For example, the microphone devices can forward the information indicative of the relative sound pressure levels to the play back device for determining the new amplitudes of the first and second of surround audio content. Alternatively, determining the amplitudes of the first and second portions of audio content may be performed by a controller device or another device with which the play back device has a network connection.

The microphones may be comprised, for example, by one or more satellite playback devices grouped with the playback device, for example, left and right rear speakers. In such a case, the signal recorded by the satellite playback devices may be averaged to approximate a signal received at the listening location. Alternatively, a microphone of a mobile device may be used to receive the output sound and forward corresponding information indicative of the SPL of the portions of audio to the device that determines the amplitudes of the first and second portions of surround audio content. As a still further alternative, microphones in the play back device may receive audio output by the playback device, and may approximate relative SPLs of the first and second portions of audio content, and/or may approximate acoustic path lengths of the first and second portions of audio content. This may be accomplished by processing the microphone signal to identify time of arrival of portions of the first and second audio content and/or by comparing the microphone feedback signal to a database of feedback signals and identifying playback environment characteristics, room dimensions, and/or acoustic path lengths based on correspondence to one or more sample microphone feedback signals from the database. Such database may reside in a remote computing device, and the steps for identifying the corresponding characteristics may be performed at the remote computing device. Information indicating the relevant characteristics and/or required relative amplitudes may be provided to the play back device by the remote computing device.

Although some embodiments disclosed herein refer to routing at least a portion of surround audio content to a forward-firing transducer and/or to a side-firing transducer, in some embodiments at least a portion of surround content can be routed multiple different transducers, some or all of which can be forward-firing. Additionally, in some embodiments side channel input can be routed to other transducers, such as up-firing transducers. In some embodiments, audio input for any channel can be routed in whole or in part to any transducer so as to achieve the desired psychoacoustic effect.

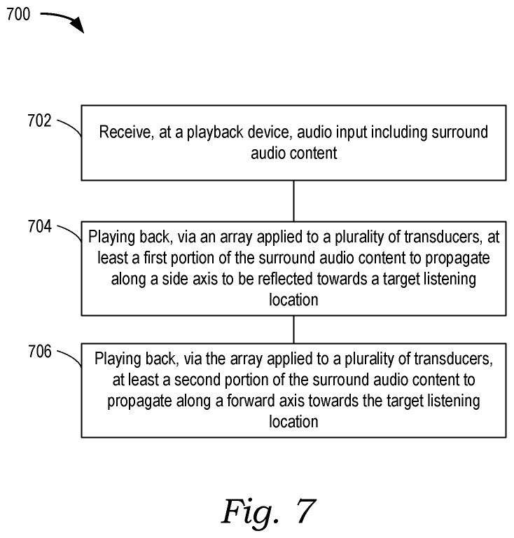

FIG. 7 is a flow diagram of an example methods for playing back audio content with enhanced immersiveness. The method 700 can be implemented by any of the devices described herein, or any other devices now known or later developed.

Various examples of the method 700 include one or more operations, functions, or actions illustrated by blocks. Although the blocks are illustrated in sequential order, these blocks may also be performed in parallel, and/or in a different order than the order disclosed and described herein. Also, the various blocks may be combined into fewer blocks, divided into additional blocks, and/or removed based upon a desired implementation.

In addition, for the method 700 and for other processes and methods disclosed herein, the flowcharts show functionality and operation of possible implementations of some examples. In this regard, each block may represent a module, a segment, or a portion of program code, which includes one or more instructions executable by one or more processors for implementing specific logical functions or steps in the process. The program code may be stored on any type of computer readable medium, for example, such as a storage device including a disk or hard drive. The computer readable medium may include non-transitory computer readable media, for example, such as tangible, non-transitory computer-readable media that stores data for short periods of time like register memory, processor cache, and Random-Access Memory (RAM). The computer readable medium may also include non-transitory media, such as secondary or persistent long-term storage, like read only memory (ROM), optical or magnetic disks, compact disc read only memory (CD-ROM), for example. The computer readable media may also be any other volatile or non-volatile storage systems. The computer readable medium may be considered a computer readable storage medium, for example, or a tangible storage device. In addition, for the methods and for other processes and methods disclosed herein, each block in FIG. 7 may represent circuitry that is wired to perform the specific logical functions in the process.

With reference to FIG. 7, the method 700 begins at block 702, which involves receiving, at a playback device, audio input including surround audio content. The surround audio content can include or be, for example, left and right surrounds, left and right rear, height (also referred to as vertical), etc. In some examples, the present technology can also be applied to left and right channel output.

In block 704, the method 700 includes playing back, via an array applied to a plurality of transducers of the playback device, at least a first portion of the surround audio content to propagate along a side axis to be reflected towards a target listening location. At the same time, as shown in block 704, the array outputs at least a second portion of the surround audio content to propagate along a forward axis towards the target listening location. As described previously, an array can be used to map a given audio input (e.g., left rear) to a plurality of transducers that work in concert to achieve the desired output (e.g., having the desired directivity and other acoustic characteristics). By use of such an array, the first portion of the surround audio content (e.g., a first portion of the total acoustic energy) may propagate along the side axis while the second portion of the surround audio content (e.g., a second portion of the total acoustic energy) may propagate along the forward axis. In various examples, the properties of these two portions can be controlled and optimized via the array design to achieve the desired psychoacoustic effects. In particular, the total acoustic energy may be greater along the side axis than the forward axis to promote the precedence effect for the listener. Additionally or alternatively, the frequency response curves can be similar for both axes, which can reduce the likelihood that the user perceives the two arrivals as representing different audio sources rather than a combined source positioned at a location that is laterally offset from the playback device.

### IV. Conclusion

The above discussions relating to play back devices, controller devices, playback zone configurations, and media content sources provide only some examples of operating environments within which functions and methods described below may be implemented. Other operating environments and/or configurations of media playback systems, play back devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software embodiments or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring embodiments of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### V. Examples

The disclosed technology is illustrated, for example, according to various examples described below. Various examples of examples of the disclosed technology are described as numbered examples (1, 2, 3, etc.) for convenience. These are provided as examples and do not limit the disclosed technology. It is noted that any of the dependent examples may be combined in any combination, and placed into a respective independent example. The other examples can be presented in a similar manner.
Example 1: A method of playing back audio content comprising: receiving, at a play back device, audio input including surround audio content, the play back device comprising a plurality of audio transducers and having a forward axis extending from the playback device toward a target listening location: playing back, via an array applied to the plurality of transducers: at least a first portion of the surround audio content propagating along a side axis to be reflected towards the target listening location, the side axis being horizontally angled with respect to the forward axis; and at least a second portion of the surround audio content propagating along the forward axis towards the target listening location, wherein the second portion of the surround audio content reaches the target listening location with a first sound pressure level (SPL) that is greater than a second SPL of the first portion of audio content at the target listening location.
Example 2: The method of any one of the Examples herein, wherein the first SPL is greater than the second SPL by at least about 1, 2, 3, 4, 5, 6, 7, 8, 9, or 10 dB.
Example 3: The method of any one of the Examples herein, wherein a first frequency response of the first portion of audio content propagating along the side axis differs from a second frequency response of the second portion of audio content propagating along the forward axis by an average of no more than about 1, 2, 3, 4, 5, 6, 7, 8, 9, 10, 11, 12, 13, 14, 15, 16, 17, 18, 19, or 20 dB over a range of having a lower end of 300, 400, 500, 600, 700, 809, 900, or 1,000 Hz, and an upper end of about 1, 1.5, 2, 2.5, 3, 3.5, 4, 4.5, 5, 5.5, 6, 6.5, 7, 7.5, 8, 8.5, 9, or 9.5 kHz.
Example 4: The method of any one of the Examples herein, wherein a first frequency response of the first portion of audio content propagating along the side axis differs from a second frequency response of the second portion of audio content propagating along the forward axis by no more than about 1, 2, 3, 4, 5, 6, 7, 8, 9, 10, 11, 12, 13, 14, 15, 16, 17, 18, 19, or 20 dB over a range of having a lower end of 300, 400, 500, 600, 700, 809, 900, or 1,000 Hz, and an upper end of about 1, 1.5, 2, 2.5, 3, 3.5, 4, 4.5, 5, 5.5, 6, 6.5, 7, 7.5, 8, 8.5, 9, or 9.5 KHz.
Example 5: The method of any one of the Examples herein, wherein the audio content comprises at least seven input channels including left, right, center, left surround, right surround, left rear, and right rear, and wherein the method further comprises combining the left surround channel and left rear channel for processing via a first array, and combining the right surround channel and right rear channel for processing via a second array.
Example 6: The method of any one of the Examples herein, wherein the audio content comprises at least nine input channels including left, right, center, left surround, right surround, left rear, right rear, left height, and right height, and wherein the method further comprises combining the left surround channel, the left rear channel, and the left height channel for processing via a first array, and combining the right surround channel, the right rear channel, and the right height channel for processing via a second array.
Example 7: The method of any one of the Examples herein, wherein the audio input comprises at least one of: 3D audio input, MPEG-H audio input, Dolby ATMOS audio input; or DTS: X audio input.
Example 8: A playback device comprising: a plurality of audio transducers; one or more processors; and data storage having instructions stored thereon that, when executed by the one or more processors, cause the playback device to perform operations comprising the method of any one of the Examples herein.
Example 9: A tangible, non-transitory, computer-readable medium having instructions stored thereon that, when executed by one or more processors of a playback device, cause the playback device to perform operations comprising the method of any one of the Examples herein.

1.-14. (canceled)

15. A playback device comprising:
at least one forward-firing transducer configured to direct sound along a forward axis of the playback device and toward an intended listening location;
at least one side-firing transducer configured to direct sound along a side axis that is horizontally angled with respect to the forward axis;
one or more processors; and
data storage having instructions stored thereon that, when executed by the one or more processors, cause the playback device to perform operations comprising:
receiving audio input including surround audio content;
playing back at least a first portion of the surround audio content via the side-firing transducer(s) such that the first portion of the surround audio propagates along the side axis to be reflected towards the listening location; and
playing back at least a second portion of the surround audio content via the forward-firing transducer(s) such that the second portion of the surround audio propagates along the forward axis towards the listening location,
such that the second portion of the surround audio content reaches the listening location with a first sound pressure level (SPL) that is greater than a second SPL of the first portion of audio content at the listening location.

16. The playback device of claim 15, wherein the first SPL is greater than the second SPL by at least 10 dB.

17. The playback device of claim 15, wherein playing back the first portion of the surround audio content via the forward-firing transducer is delayed with respect to playing back second portion of the surround audio content via the side-firing transducer.

18. The playback device of claim 15, wherein the audio content comprises at least seven input channels including left, right, center, left surround, right surround, left rear, and right rear, and wherein the operations further comprise combining the left surround channel and left rear channel for processing via a first array, and combining the right surround channel and right rear channel for processing via a second array.

19. The playback device of claim 15, wherein the audio content comprises at least nine input channels including left, right, center, left surround, right surround, left rear, right rear, left height, and right height, and wherein the operations further comprise combining the left surround channel, the left rear channel, and the left height channel for processing via a first array, and combining the right surround channel, the right rear channel, and the right height channel for processing via a second array.

20. The playback device of claim 15, wherein the audio input comprises at least one of: 3D audio input, MPEG-H audio input, Dolby ATMOS audio input, or DTS: X audio input.

21. The playback device of claim 15, wherein a first frequency response of the first portion of the surround audio content differs from a second frequency response of the second portion of the surround audio content by an average of no more than about 10 dB over a range of about 300 Hz to about 5 KHz.

22. A method of playing back audio content comprising:
receiving, at a playback device, audio input including surround audio content, the playback device comprising:
at least one forward-firing transducer configured to direct sound along a forward axis of the playback device and toward an intended listening location; and
at least one side-firing transducer configured to direct sound along a side axis that is horizontally angled with respect to the forward axis;
playing back at least a first portion of the surround audio content via the side-firing transducer(s) such that the first portion of the surround audio propagates along the side axis to be reflected towards the listening location; and
playing back at least a second portion of the surround audio content via the forward-firing transducer(s) such that the second portion of the surround audio propagates along the forward axis towards the listening location,
wherein the second portion of the surround audio content reaches the listening location with a first sound pressure level (SPL) that is greater than a second SPL of the first portion of audio content at the listening location.

23. The method of claim 22, wherein the first SPL is greater than the second SPL by at least 10 dB.

24. The method of claim 22, wherein playing back the first portion of the surround audio content via the forward-firing transducer is delayed with respect to playing back second portion of the surround audio content via the side-firing transducer.

25. The method of claim 22, wherein the audio content comprises at least seven input channels including left, right, center, left surround, right surround, left rear, and right rear, and wherein the method further comprises combining the left surround channel and left rear channel for processing via a first array, and combining the right surround channel and right rear channel for processing via a second array.

26. The method of claim 22, wherein the audio content comprises at least nine input channels including left, right, center, left surround, right surround, left rear, right rear, left height, and right height, and wherein the method further comprises combining the left surround channel, the left rear channel, and the left height channel for processing via a first array, and combining the right surround channel, the right rear channel, and the right height channel for processing via a second array.

27. The method of claim 22, wherein the audio input comprises at least one of: 3D audio input, MPEG-H audio input, Dolby ATMOS audio input; or DTS: X audio input.

28. The method of claim 22, wherein a first frequency response of the first portion of the surround audio content differs from a second frequency response of the second portion of the surround audio content by an average of no more than about 10 dB over a range of about 300 Hz to about 5 KHz.

29. One or more tangible, non-transitory computer-readable media storing instructions that, when executed by one or more processors of a playback device comprising at least one forward-firing transducer configured to direct sound along a forward axis of the playback device and toward an intended listening locations and at least one side-firing transducer configured to direct sound along a side axis that is horizontally angled with respect to the forward axis, cause the playback device to perform operations comprising:
receiving, at the playback device, audio input including surround audio content;
playing back at least a first portion of the surround audio content via the side-firing transducer(s) such that the first portion of the surround audio propagates along the side axis to be reflected towards the listening location; and
playing back at least a second portion of the surround audio content via the forward-firing transducer(s) such that the second portion of the surround audio propagates along the forward axis towards the listening location,
wherein the second portion of the surround audio content reaches the listening location with a first sound pressure level (SPL) that is greater than a second SPL of the first portion of audio content at the listening location.

30. The computer-readable media of claim 29, wherein the first SPL is greater than the second SPL by at least 10 dB.

31. The computer-readable media of claim 29, wherein playing back the first portion of the surround audio content via the forward-firing transducer is delayed with respect to playing back second portion of the surround audio content via the side-firing transducer.

32. The computer-readable media of claim 29, wherein the audio content comprises at least seven input channels including left, right, center, left surround, right surround, left rear, and right rear, and wherein operations further comprise combining the left surround channel and left rear channel for processing via a first array, and combining the right surround channel and right rear channel for processing via a second array.

33. The computer-readable media of claim 29, wherein the audio content comprises at least nine input channels including left, right, center, left surround, right surround, left rear, right rear, left height, and right height, and wherein the operations further comprise combining the left surround channel, the left rear channel, and the left height channel for processing via a first array, and combining the right surround channel, the right rear channel, and the right height channel for processing via a second array.

34. The computer-readable media of claim 29, wherein the audio input comprises at least one of: 3D audio input, MPEG-H audio input, Dolby ATMOS audio input; or DTS: X audio input.
